(19) United States
(12) Patent Application Publication
(10) Pub. No.: US 2018/0200927 A1
(43) Pub. Date: Jul. 19, 2018

(54) FOAMED RESIN PRODUCTION METHOD AND PRODUCTION EQUIPMENT THEREOF

(71) Applicant: Nippon Sosey Kogyo Co., Ltd., Nagoya (JP)

(72) Inventor: Norihiro MORIKAWA, Nagoya (JP)

(21) Appl. No.: 15/606,165

(22) Filed: May 26, 2017

(30) Foreign Application Priority Data
Jan. 13, 2017 (JP) 2017-004068

(51) Int. Cl. B29C 44/34; B29C 44/02; B29B 7/00; B29B 7/22; B29C 31/02

(52) U.S. Cl. CPC B29C 44/3442; B29C 44/02; B29K 2105/04; B29B 7/22; B29C 31/02; B29B 7/005

(57) ABSTRACT

[Problem to be Solved] After being filled into a mold, a mixed material will be cured while gradually foaming and expanding.

[Solution] The equipment is provided with supply parts 1, 2 of two types of chemical liquids A, B and a mixer 3 for mixing two types of the chemical liquids supplied from the chemical liquid supply parts 1, 2. And, a storage tank 8 of gas which is to be dissolved in the stored chemical liquid A under pressure is connected to one of chemical liquid storage tanks, that is, the chemical liquid storage tank 4 at the chemical liquid supply part 1, in an instant when a mixed material of the chemical liquids A, B is externally discharged, a dissolved gaseous component is allowed to foam. Thereby, the soft mixed material before the curing reaction can be cured completely after being filled into a mold in a foaming and expanding state.

### TECHNICAL FIELD

The present invention relates to a foamed resin production method by mixing two types of chemical liquids and also to its production equipment.

### BACKGROUND ART

As a conventional method for producing foamed resin products, for example, a foamed silicone product, there is found a method in which a mixed material of liquid silicone with a foaming agent is filled into a mold and the mixed material is thereafter allowed to foam, thereby providing a foamed silicone product with a predetermined shape (for example, refer to Patent Document 1).

### PRIOR ART DOCUMENT

### Patent Document

[Patent Document 1] Japanese Published Unexamined Patent Application No. 2000-254927

### DISCLOSURE OF THE INVENTION

### Problem to be Solved by the Invention

However, in the above-described conventional technology, for example, where a different component is placed inside a molded product, a mixed material is filled into a mold and then gradually cured while foaming and gradually expanding, and, therefore, the different component which has been set inside the mold is pressed by the mixed material which undergoes gradual expansion and curing. Thereby, the different component results in a positional deviation or, there is a risk that, in the worst case, the different component may be broken, etc., therefore, this is a problem to be solved.

### Means for Solving the Problem

In view of the problem derived from the above-described conventional technology in which the mixed material is cured while gradually foaming and expanding after being filled into a mold, in the present invention, such a process is conducted that a gas is dissolved in at least one of the chemical liquids under pressure, thereafter, both the chemical liquids are mixed, and in an instant when a mixed material is externally discharged, a dissolved gaseous component is allowed to foam, by which the soft mixed material before the curing reaction can be cured completely after being filled into a mold in a foaming and expanding state. The above-described problem is thus solved.

### Effects of the Invention

In short, the present invention is such that a process is conducted in which a gas is dissolved in at least one of chemical liquids under pressure, thereafter, both the chemical liquids are mixed, and in an instant when a mixed material is externally discharged, a dissolved gaseous component is allowed to foam, by which the mixed material which has completed foaming but has not completed curing and is still soft can be filled, thereby making it possible to prevent positional deviation or breakage at the time of embedding other components.

Further, any kind of resin or rubber can be made into a porous substance such as foam or sponge, by which a molded product can be made lighter in weight.

In a two-liquid mixing system, a formulation ratio of two types of chemical liquids is important, and it is practically impossible to measure a supply quantity of foam-containing chemical liquid by using a liquid quantity measuring means. Thus, in the present invention, a gaseous component in a state of being dissolved is contained in a chemical liquid. Therefore, the present invention is able to realize quite useful practical effects such as accurate measurement by using a liquid quantity measuring means.

### BRIEF DESCRIPTION OF THE DRAWINGS

FIG. 1 is a schematic view which shows foamed resin production equipment according to the present invention.

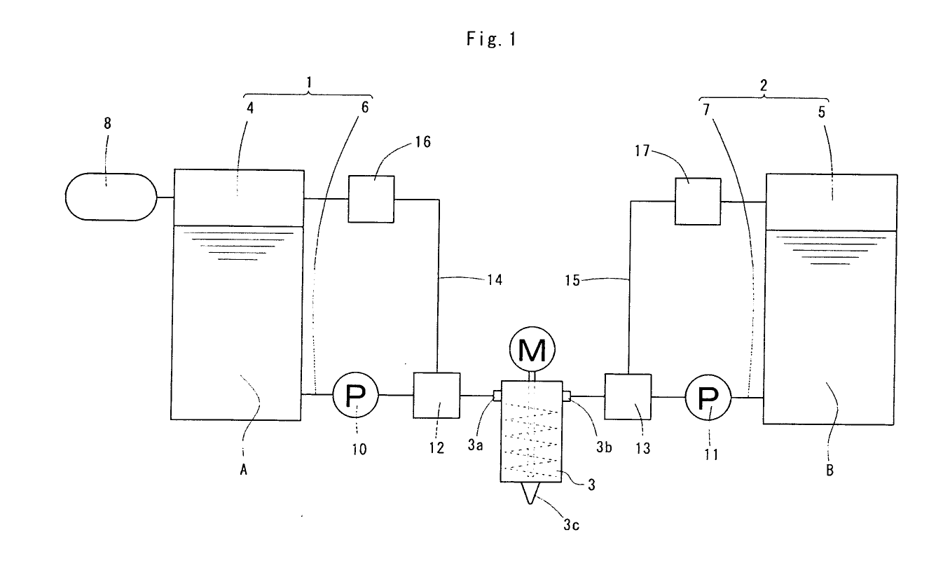

### MODE FOR CARRYING OUT THE INVENTION

The foamed resin production equipment of the present invention is basically provided with supply parts 1, 2 of two types of chemical liquids A, B (for example, a main agent A and a curing agent B) and a mixer 3 which mixes two types of chemical liquids supplied from the chemical liquid supply parts 1, 2.

The chemical liquid supply parts 1, 2 are respectively provided with storage tanks 4, 5 which store the chemical liquids A, B and flow channels 6, 7 of the chemical liquids A, B provided between the storage tanks 4, 5 and the mixer 3.

One of the storage tanks, that is, the storage tank 4 of the chemical liquid A is connected to a storage tank 8 of gas which is to be dissolved in the stored chemical liquid A under pressure.

In the chemical liquid flow channels 6, 7, upstream ends thereof are respectively connected to lower parts of the chemical liquid storage tanks 4, 5, downstream ends thereof are respectively connected to inlets 3a, 3b of the mixer 3, pumps 10, 11 are provided at intermediate parts, the pumps 10, 11 are used to measure a predetermined quantity of each of the chemical liquids A, B inside the chemical liquid storage tanks 4, 5, thereby, the chemical liquids can be supplied into the mixer 3 via the chemical liquid flow channels 6, 7 and the inlets 3a, 3b, a mixed material of the thus mixed chemical liquids A, B can be externally discharged through a nozzle 3c at a lower part of the mixer 3, and the nozzle 3c is made smaller in inner diameter or an orifice is provided inside, by which a pressurized state can be retained to prevent foaming before discharge.

Switching valves 12, 13 are respectively provided further downstream from the pumps 10, 11 on the chemical liquid flow channels 6, 7, and each of the switching valves 12, 13 is provided with one inlet and two outlets. Downstream ends of upstream sites on the chemical liquid flow channels 6, 7 are respectively connected to inlets of the switching valves 12, 13, upstream ends of downstream sites on the chemical liquid flow channels 6, 7 are respectively connected to outlets of one of the switching valves 12, 13. And, there are provided return flow channels 14, 15 of the chemical liquids A, B respectively between the other outlets of the switching valves 12, 13 and upper parts of the chemical liquid storage tanks 4, 5.

Pressure adjusting valves 16, 17 are provided respectively on the return flow channels 14, 15, thus making it possible to reliably prevent foaming inside the chemical liquid supply parts 1, 2.

Then, a gas is first supplied from the storage tank 8 to one of the chemical liquid storage tanks, that is, the chemical liquid storage tank 4, a necessary quantity of the gas is dissolved in the chemical liquid A under pressure, and the switching valves 12, 13 are then used to open one of the outlets and close the other of the outlets, by which both the chemical liquids A, B are supplied at predetermined quantities from the chemical liquid storage tanks 4, 5 via the chemical liquid flow channels 6, 7 and the inlets 3a, 3b into the mixer 3, thereafter, the chemical liquids A, B are mixed inside the mixer 3, after completion of mixture, a mixed material is externally discharged through the nozzle 3c at the lower part of the mixer 3, the mixed material instantly foams and expands inside and is gradually cured to produce foamed resin products.

Further, the switching valves 12, 13 are used to close one of the outlets and open the other of the outlets, the chemical liquids A, B are returned from the chemical liquid storage tanks 4, 5 to the chemical liquid storage tanks 4, 5 via the chemical liquid flow channels 6, 7 and the return flow channels 14, 15, by which the chemical liquids A, B can be circulated to make homogeneous the chemical liquids A, B inside the chemical liquid supply parts 1, 2, and the foamed resin products can be made uniform in quality.

It is noted that any resin may be used in the production method and the production equipment according to the present invention, as long as it is a two-liquid mixing type resin.

Further, a mixed material of the chemical liquids A, B is set so as to be appropriate in terms of viscosity, change in viscosity with the lapse of time (thixotropy) and curing rate depending on a situation, by which no gaseous component will be removed from the mixed material to lose bubbles before curing of the mixed material.

Still further, in the above-described embodiment, the storage tank 8 is connected only to one of the chemical liquid storage tanks, that is, the chemical liquid storage tank 4. In short, however, it suffices that as long as the storage tank 8 is connected to at least one of the chemical liquid storage tanks 4, 5.

### DESCRIPTION OF THE SYMBOLS

1, 2: chemical liquid supply part
3: mixer
4: chemical liquid storage tank
8: storage tank
A, B: chemical liquid

1. A foamed resin production method by mixing two types of chemical liquids,
the foamed resin production method, wherein there is conducted a process in which a gas is dissolved in at least one of the chemical liquids under pressure, thereafter, both the chemical liquids are mixed and in an instant when a mixed material is externally discharged, a dissolved gaseous component is allowed to foam.

2. Foamed resin production equipment: comprising supply parts of two types of chemical liquids; and a mixer for mixing two types of the chemical liquids supplied from the supply parts of the chemical liquids,
wherein a storage tank of gas which is to be dissolved in the stored chemical liquid under pressure is connected to at least one of the chemical liquid storage tanks at the chemical liquid supply parts, by which in an instant when a mixed material of two types of the chemical liquids is externally discharged, a dissolved gaseous component is allowed to foam.
